(19) United States
(12) Patent Application Publication
(10) Pub. No.: US 2004/0031056 A1
(43) Pub. Date: Feb. 12, 2004

(54) Method and system for delivering service provider content to subscribers

(76) Inventor: Christopher J. Wolff, Tucson, AZ (US)

Correspondence Address: WEISS & MOY PC, 4204 NORTH BROWN AVENUE, SCOTTSDALE, AZ, 85251, US

(21) Appl. No.: 10/214,810

(22) Filed: Aug. 7, 2002

(51) Int. Cl. H04N 7/173; H04N 7/20

(52) U.S. Cl. 725/110; 725/109; 725/118; 725/73

(57) ABSTRACT

A method and system for delivering service provider content to a subscriber provides a platform for transmission and reception of traditionally analog media to and from a subscriber. A virtual private network is set-up between a dedicated set-top box and the service-provider server and a data stream that carries aggregated media information to and from the set-top box and the server. That aggregated media information can include live and prerecorded video sources, local telephone, long-distance telephone and Internet access.

### BACKGROUND OF THE INVENTION

1. Field of the Invention

The present invention relates generally to multimedia content delivery, and more specifically, to a method and system for delivering traditionally analog content from a service provider to subscribers.

2. Background of the Invention

The proliferation of data service connections to sites such as homes and businesses has provided an infrastructure providing a continually increasing data bandwidth to those sites. Service providers such as telecommunications service providers, entertainment providers and Internet Service Providers (ISPs) may connect through various existing Internet or private connection techniques such as streaming video, voice-over-Internet, et cetera. However, on-time and high-quality delivery are required for Internet-based or private connection services to compete adequately with existing hard-wired or satellite providers.

It would be desirable to provide a unified structure for delivering the above-mentioned services, as some infrastructure requirements could be unified so that a single connection and a single service provider can provide all or some of the above-mentioned services, and provide unified billing to a subscriber.

However, control of bandwidth allocation and data timing priorities has typically been unavailable across the above-mentioned services, due to differing protocols and standards that are in place. A mere combination of typical service provider content would cause competition for response time and bandwidth, resulting in inferior delivery of service provider content.

Also, existing analog equipment (e.g., standard televisions and telephones) owned by the subscribers to the various existing services represents an investment in the existing infrastructures. The cost of replacing existing analog equipment with digital equipment represents an entry cost that should be avoided in any system that replaces existing service provider infrastructures.

Therefore it would be desirable to provide a method and system for delivering video, telecommunications and Internet services over a unified connection, whereby on-time and high-quality delivery of service provider content may be ensured. It would further be desirable to provide such a method and system that will retain compatibility with existing analog equipment.

### SUMMARY OF THE INVENTION

The above objective of delivering on-time and high-quality video, telecommunications and Internet services over a unified connection in a manner compatible with existing analog equipment is achieved in a method and system for delivering service provider content to subscribers. The method and system aggregate video streams from satellite connections, telecommunications streams from packet-switched telecommunications connections and Internet connections, providing a unified data stream for transmission to a subscriber set-top interface.

Computer program products for execution on an end-user computer or a server may implement methods of the present invention. Methods in accordance with embodiments of the invention may be incorporated within a set-top box for interfacing a data network connection to video displays, digital telephones and computers.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a block diagram depicting a system in accordance with an embodiment of the present invention.

FIG. 2 is a block diagram depicting a service provider facility in accordance with an embodiment of the present invention.

FIG. 3 is a block diagram depicting a set-top box in accordance with an embodiment of the present invention.

### DETAILED DESCRIPTION OF THE PREFERRED EMBODIMENTS

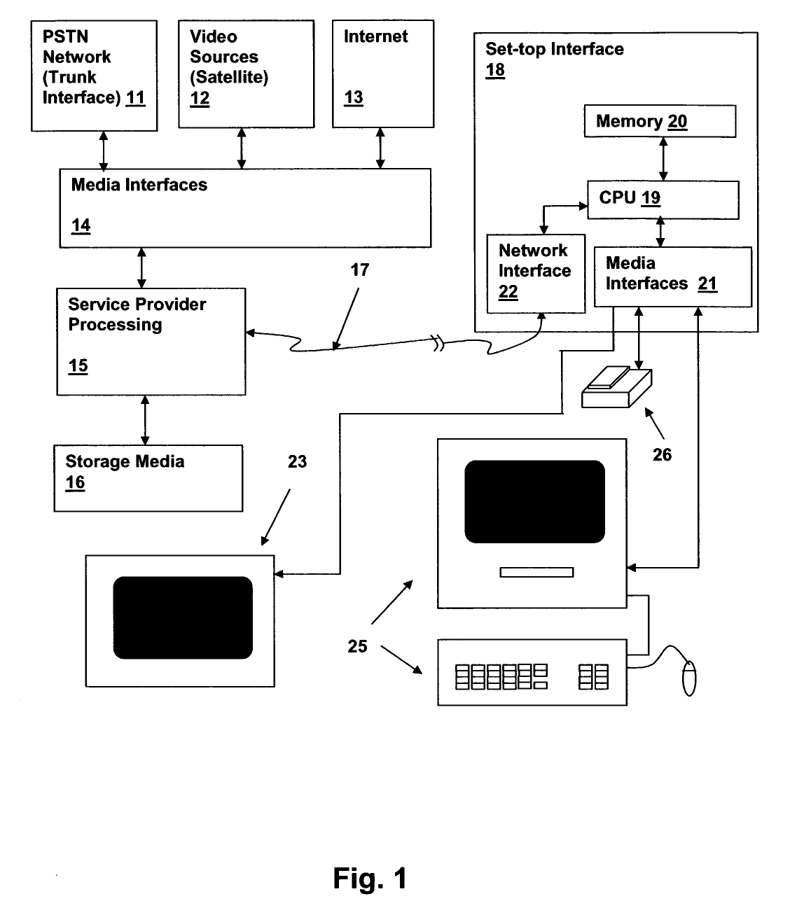

Referring to the Figures, and in particular to FIG. 1, a system in accordance with an embodiment of the present invention is depicted. Service provider processor 15 is coupled to various media interfaces 14 that supply traditionally analog connections (telephone and video) as well as Internet data communications connections. A public-switched telephone network (PSTN) network trunk interface 11 provides a connection from the service provider equipment to telephone service providers. The trunk interface 11 is a high connection-density interface providing multiple simultaneous telephone conversations. Connection to the PSTN is regulated and monitored by the service provider to provide long distance or per-connection billing.

Media interfaces 14 also include an interface to the Internet 13, which may be another trunk interface connecting to a telephone central office, a fiber backplane connection to an Internet service provider (ISP), a satellite Internet connection, or other suitable means for providing an interface to Internet data communications. Media interfaces 14 also includes a connection to various video sources 12, which will generally be one or more satellite dishes and receivers, but may include standard television antennas and receivers, or cable television connections.

Service provider processor 15 combines information flowing in both direction from the media interfaces 14 (with the exception of video source 12 signals which are typically incoming only) and provides a unified transport stream via a private network connection 17, to a subscriber-side set-top interface 18. Set-top interface 18 includes a processor 19 coupled to a memory 20 and a network interface 22 for coupling to private network connection 17. Set-top interface 18 also includes media interfaces 21 for interfacing signals decomposed by processor 19 from the unified stream received over private network connection 17.

Media interfaces 22 include a standard telephone connection for interface to a standard telephone device 25, which may be a analog plain old telephone system (POTS) device or a digital telephone device. Media interfaces 22 also include a video interface for connection to a standard video device 23, which may be a television, analog monitor, or other standard video display device. Finally, media interfaces 22 includes a computer network interface for connection to a standard personal computing system 25, generally via an Ethernet connection.

In general, the present invention includes a service provider system for combining information from various media sources and delivering them to standard devices within subscriber premises. Billing and administrative control is performed at the service provider side, while user selection of billed items (such as pay-per-view, long distance dialing) is provided by communication between the administrative control system and the set-top interface. Thus, the present invention provides a mechanism for delivering unified subscription services to a subscriber, with a minimal investment in subscriber-side equipment.

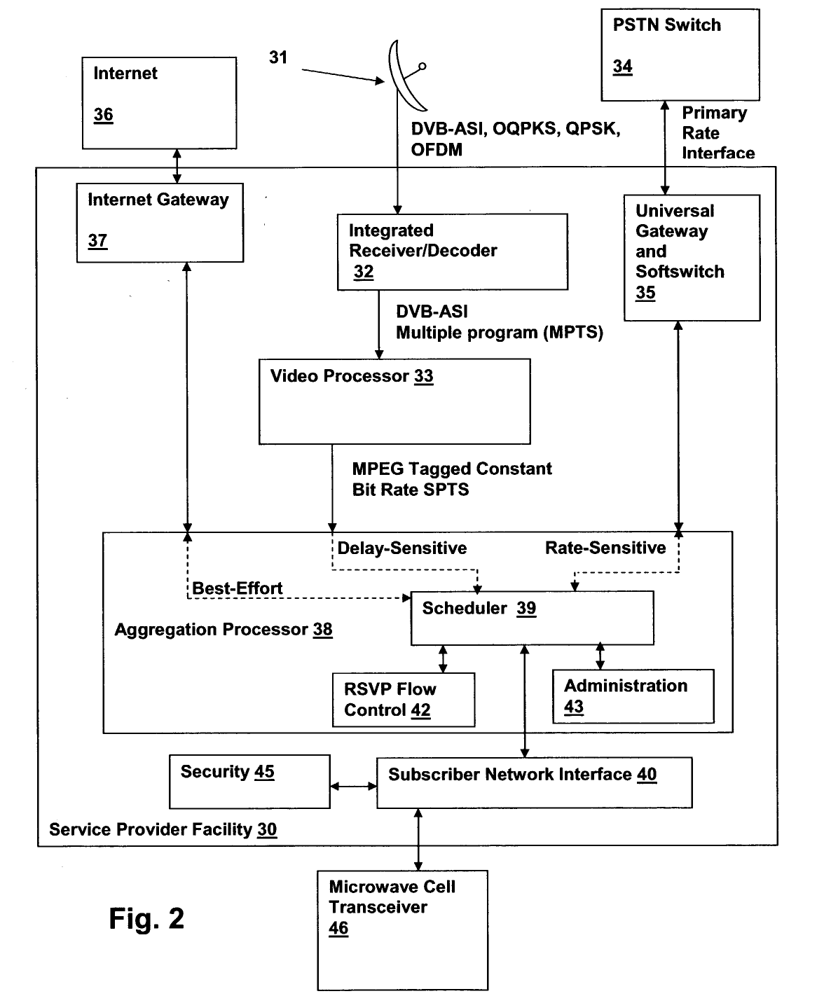

Referring now to FIG. 2, details of a service-provider facility in accordance with an embodiment of the invention is depicted. The first stage in providing unified services is the step of acquisition. The video acquisition process involves encoding live and prerecorded video information from traditional analog and digital media sources. The source information is encoded into unicast and multicast UDP/IP or TCP/IP streams and delivered to the subscriber. Multiplexed video data is generally received at the service provider facility via an L or Ku band satellite dish 31. The incoming data may be modulated in either quadrature phase-shift key (QPSK), offset QPSK, offset frequency-division multiplex (OFDM), or digital video broadcasting over asynchronous serial interface DVB-ASI. An Integrated Receiver-Decoder (IRD) 32 will strip the forward error correction (FEC) satellite encryption from the video signals and output a clear channel DVB-ASI signal to a video processor 33.

Video processor 33 grooms the video signals to match the capacity of each subscriber's network connection while permitting rapid channel changing. The DVB-ASI video signal is converted from a variable bit rate (VBR) multiple program transport stream (MPTS) to multiple instances of single program transport streams (SPTS) of constant bit rate (CBR). Video processor 33 encodes each of the demultiplexed SPTS signals into MPEG2 format at a CBR of 4.5 megabits/sec. Video processor 33 also tags each streams with a channel identifier and Quality-of-service parameters, and outputs the streams as a unicast or multicast Real-Time-Protocol (RTP) packet over Gigabit Ethernet or ATM to an aggregation processor 38. Access to the transport streams is limited by subscriber management software that permits or denies access based on criteria established by the service provider.

Telephone connections are provided by an interface to the local PSTN switch 34 via digital trunks—Primary Rate Interfaces (PRI) that connect to a universal gateway 35. Universal gateway 35 interfaces with the aggregation processor via Fast Ethernet, Gigabit Ethernet, or ATM. Universal gateway 35 provides call translation services between the PSTN and signaling system (SS7), H.323 (a standard promulgated by the International Telecommunications Union), Media Gateway Control Protocol (MGCP), and/or session initiation protocol (SIP) subscribers. Universal gateway is connected to aggregation processor 38, which combines telephonic data with the video streams from video processor 33 as well as from Internet gateway 37 (described below).

Call setup and teardown is coordinated through a software switch (softswitch) within universal gateway 35 that maps PSTN trunks 34 to IP endpoints on private network connection (17 of FIG. 1). The softswitch also provides enhanced voice services, including voicemail, call transfer, call park, and caller-id. Operation of the gateway may be seen in the following example: A PSTN endpoint initiates an incoming call is recorded at universal gateway 35. Universal gateway 35 notifies the softswitch that a call is incoming and asks the softswitch to determine what IP endpoint (i.e., which subscriber) is to receive the call. The softswitch then contacts the IP endpoint and initiates a handshake between the subscriber endpoint and universal gateway 35.

Internet information is retransmitted throughout the UBP in its native form, TCP/IP over Ethernet or ATM. No encoding or decoding process is required to package Internet information for the subscriber. Internet gateway 37 provides an interface to the Internet backplane 36 and connects to aggregation processor 38, where Internet data is combined with the telephone data from universal gateway 35 and video streams from video processor 33.

The next stage in providing unified services is aggregation. Aggregation processor 38 combines the individual data streams generated in the acquisition stage and shapes them into a network-friendly package of digital content for delivery to the private network 17 via subscriber network interface 40. A scheduler 39 is responsible for ordering packets and maintaining QoS management for the components of the unified data stream.

In traditional data networks, each data packet contends equally for available bandwidth on a connection. Equal contention compromises the delivery of time-sensitive data, such as voice and video. If, for example, a web page is retrieved at the same time that a digital voice conversation is taking place, data packets that make up the web page may undesirably take precedence over the data packets that make up the voice conversation.

In the aggregation stage, voice, video and data streams are given three distinct flow specifications. A flow specification describes the level of service required for that dataflow. In the UBP context there are three flows: Best effort flows, Rate-sensitive flows, and Delay-Sensitive flows. Traditional data traffic: (i.e., web surfing, email, ftp) is specified as a Best Effort flow. Best Effort traffic utilizes the native resiliency features of TCP/IP and therefore does not require special prioritization. Voice traffic (over H.323 protocol for example) requires a guaranteed transmission rate from its source to its destination. This is often referred to as guaranteed-bit-rate service. Voice traffic is given a Rate-Sensitive flow specification. Video traffic poses a delivery challenge. MPEG video codecs may vary the bandwidth requirements based on the amount of change in the video frame. A guaranteed bit rate is not as critical as the delivery of the MPEG packet within a guaranteed time frame. Therefore, video streams are given a Delay-sensitive flow specification.

Aggregation processor 38 utilizes RSVP (Resource Reservation Protocol) to perform the flow classification tasks noted above. The RSVP resource-reservation process initiation begins when an RSVP daemon consults the local routing protocol(s) to obtain routes. RSVP flow control 42 manages flow from service provider facility 30 and manages RSVP reservation from the service provider side, but other RSVP-enabled devices along private network 17 paths will be engaged in the resource-reservation process.

A subscriber set-top interface 18 along private network 17 sends IGMP messages to join a multicast group and RSVP messages to reserve resources along the delivery path from that group. Each RSVP enabled router along the delivery path passes incoming data packets to a packet classifier and queues them as necessary in a packet scheduler. The RSVP packet classifier determines the route and QoS class for each packet. The RSVP scheduler allocates resources for transmission on the particular data link layer medium used by each interface. If the data link layer medium has its own QoS management capability, the packet scheduler is responsible for negotiation with the data link layer to obtain the QoS requested by RSVP. The scheduler allocates packet-transmission capacity on a QoS-passive medium, such as a leased line, and also can allocate other system resources, such as CPU time or buffers. A QoS request, typically originating in a receiver host application, is passed to the local RSVP implementation as an RSVP daemon.

The RSVP protocol is used to pass a request to all the nodes (routers and hosts) along the reverse data path to the service provider facility 30. At each node, the RSVP program applies a local decision procedure called admission control to determine whether it can supply the requested QoS. If admission control succeeds, the RSVP program sets the parameters of the packet classifier and scheduler to obtain the desired QoS. If admission control fails at any node, the RSVP program returns an error indication to the application that originated the request.

Unfortunately, not all transport mechanisms in the path will certainly support RSVP. DSL, Cable Modems, and Wireless transceivers may be integrated from different manufacturers and therefore present a RSVP interoperability issue. The lack of RSVP support is transcended through RSVP tunneling between set-top interface 18 and service provider facility 30. Set-top interface 18 supports RSVP flow control whether or not RSVP is supported by intermediate distribution devices.

Traditional analog video requires between 3 and 10 megabits/second of network capacity per MPEG2 stream. Therefore it is not practical to deliver individual video data streams to each subscriber. The video streams are therefore converted into a multicast environment, where only a single video stream is transmitted to each recipient group, regardless of the number of clients that will view it. The video stream is then replicated as required to allow an arbitrary number of clients to subscribe to the multicast address and receive the broadcast.

Multicast routing from service provider facility 30 utilizes a sparse mode technique. Sparse mode multicast routing assumes that relatively few routers in the network will be involved in each multicast. Since the subscribers are widely distributed geographically and have different television viewing preferences, the multicast distribution tree will start empty and add branches only as the result of subscriber requests to join distribution of a particular stream. Each authorized subscriber triggers a response from the distribution tree and joins a multicast group by transmitting an Internet Group Management Protocol (IGMP) message to their local multicast router.

The Administration 43 component of Aggregation processor 38 manages and controls the flow of digital content to consumers. Administration takes two forms in the UBP context: server and client. On the server side (service provider facility 30), digitally encoded voice and video data is “inventoried” so that customer access (long-distance phone calls, pay-per-view video) can be accurately tracked and billed. Furthermore, Administration 43 provides an opportunity to insert advertisements and customer notifications into the data stream. Finally, Administration 43 component performs a network monitoring function that proactively senses hardware failures and network congestion to prevent interruptions in service.

On the client side (set-top interface 18), Administration 43 component presents functional menus and/or displays including: an electronic program guide, pay-per-view options, view/pause/record live television, personal media library management menus, and parental control option menus. Although service provider facility 30 can provide Internet connectivity to subscribers, it is important to note that privat network 17 is not a public Internet network. Private network 17 is controlled exclusively by the unified service provider. Exclusive control is necessary to preserve the integrity of the data flowing through the network as well as managing Quality of Service as described above. Therefore, it is also critical for the service provider to exclude external traffic, whether malicious or not. A security component 44 provides intrusion detection and firewall processing. Similarly, content providers will not always allow a service provider to resell content without some level of assurance that only authorized clients may view the content. Therefore, each video stream is encoded by video processor 33 with one or more Digital Rights Management/Conditional Access System solutions, for example, Philips Cryptoworks.

The next stage in providing unified services is delivery. Services are delivered via a closed-loop network that begins with the transmission of the unified data stream from service provider facility 30 and ends with the reception of the data stream at set-top interface 18. Although there are several delivery mechanisms capable of supporting the capacity requirements, including FTTx, the primary delivery mechanism employed is microwave radio. Subscriber network interface 40 is coupled to microwave cell transceiver 41 providing connection to other cells and subscriber set-top interfaces 18 within the range of transceiver 41. Although the service provider facility 30 is shown as coupled directly to transceiver 41, other arrangements are possible such as fiber connection to the cellular tower, or a non-tower transceiver connection from service provider facility 30 to the cellular network.

In an ideal environment, microwave transceiver 41 cells provide coverage in a radius around a tower or base station. However, in a real environment, cells do not provide radial coverage due to geographical features, interference from buildings, antenna patterns, and preexisting radio frequency interference. The preferred cell coverage strategy employed in the present invention is a strategy employing overlapping micro cells. Each cell tower uses a distinct operating frequency to cover a limited (<2 mi) radius that overlaps adjacent cells. By overlapping cell coverage, a more uniform RF energy distribution is generated, aiding receiving radio equipment in overcoming coverage limitations presented by topographical features. In the overlapping micro cell model, unique frequencies are used between a cell tower and directly adjacent cells. Non-adjacent cells can reuse the frequencies deployed at other non-adjacent cells. The result is efficient use of limited microwave spectrum, while maintaining isolation between cell pairs.

The initial deployment of the microwave radio system employs unlicensed microwave frequencies that used in many applications. Therefore, interference rejection mechanisms must be used to guarantee quality of service and overcome signals transmitted by competing entities. The microwave transceiver systems used herein employ spectrum shielding technologies that tailor the antenna design and employ spatial interference rejection algorithms. Most existing microwave systems use linearly polarized antennas. The microwave system of the present invention utilizes a circularly polarized antenna. Circular polarization provides about 25 Db of signal rejection from linearly polarized interfering source. Furthermore, each microwave transceiver 41 incorporates real-time spatial interference rejection technologies. Transceiver 41 senses variations in received signals (interference) over 100 times per second and blocks and/or filters interfering radio communications.

While the illustrative embodiment is described as a microwave connection between set-top interfaces 18 and service provider facility 30, the present invention contemplates that the IP backbone (UDP/IP or TCP/IP) providing the private network 17 of the present invention may be routed through any suitable mechanism, including cable modem, DSL, fiber network, etc. The private network 17 present invention may be routed through a connection involving one or all of the above-mentioned technologies.

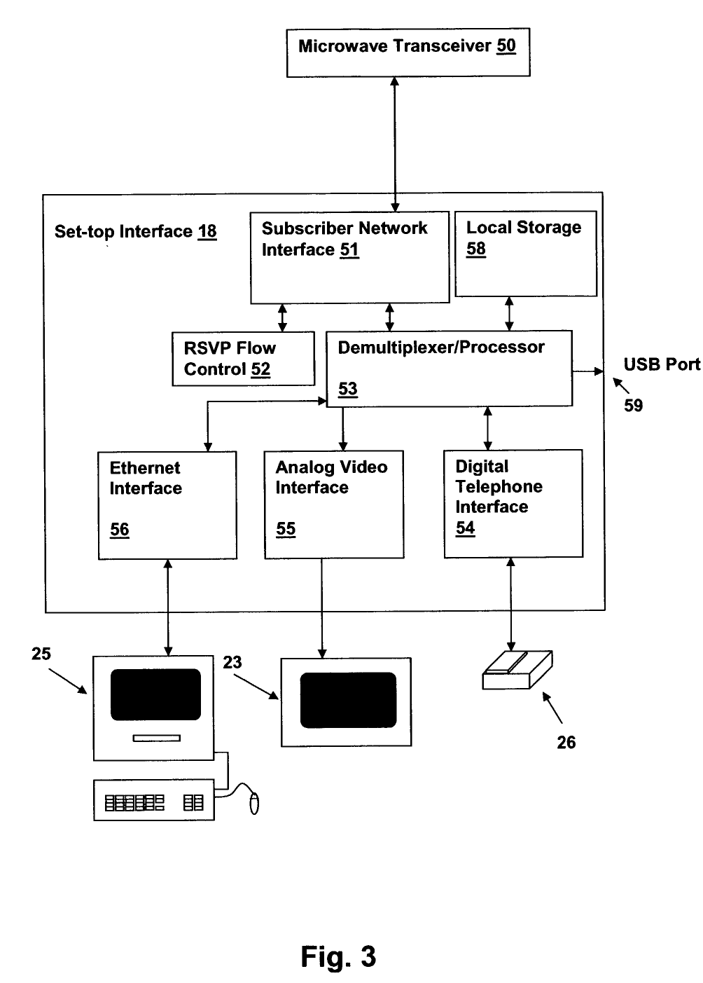

Referring now to FIG. 3, details of set-top interface 18 are depicted. Microwave transceiver 50 connects set-tip interface 18 to the microwave cellular network described above. Transceiver 50 includes an outdoor radio unit with an integrated antenna. Each transceiver 50 is connected to the client equipment with a single 4-pair data cable that integrates data and power. Set-top interface 18 interfaces with microwave radio transceiver 50 over a 10/100 mbit Fast Ethernet connection through an RJ45 connector. Data communications are duplexed using a standard time division duplex (TDD) method. Transceiver 50 utilizes an adaptive modulation mechanism based on 16QAM rate ¾ modulation.

The final stage in providing unified services is consumption. The consumption process is the presentation of service provider content to the subscriber. The consumption stage of the present invention does not require the client to purchase any new telephone, computer, or television equipment. Connection to a subscriber's existing equipment not only reduces the startup cost of the subscriber site equipment provided by the service provider, but minimizes the lifestyle impact on the subscriber.

The consumption stage begins with the connection of the unified data stream from microwave transceiver 50 to subscriber network interface 51. The unified data stream is demultiplexed by a demultiplexer 53 which converts the unified data stream into the original analog and digital data streams. Set-top interface 18 registers with upstream routers in order to join a video multicast network. Set-top interface also registers with universal gateway (35 of FIG. 1) soft switch, enabling voice connectivity to the PSTN. Registration is employed to enable limiting services in the event of delinquent billing, etc.

Set-top interface 18 completes the Quality of Service loop initiated at the core through the preservation of QoS and RSVP attributes to the subscriber. Conversely, packet traffic entering the set-top interface 18 from the subscriber's computer 25 or telephone 26 is tagged with the appropriate attributes to ensure consistency in real time information delivered to the core. Voice services are delivered to the customer through the set-top interface via one or more RJ11 ports which interface with most existing single line telephones 26. Telephone interface 54 encodes and decodes analog voice information into a corresponding standard voice protocol such as G.711 or G.729. Service provider facility 30 may manipulate the encoding protocol and voice quality based on the available bandwidth at universal gateway 35 or based on the bandwidth of the connection to set-top interface 18. For example, a subscriber connecting over an xDSL connection has less available bandwidth than a subscriber connecting via microwave transceiver 50 and therefore an encoding scheme may be chosen that balances voice quality with available bandwidth.

Video services are delivered to one or more television sets 23 through set-top interface 18 composite or S-Video interfaces. Dolby AC3 audio is delivered with the MPEG1, MPEG2, or MPEG4 stream through an S/PDIF interface. The video component of set-top interface 18 provides many special features. Macrovision copy protection is employed to prevent unauthorized copying of video content. Picture in Picture capability is provided for multi-channel viewing or simultaneous viewing of menus and video or for overlaid advertisements. An MP3 jukebox is provided, as well as a universal serial bus (USB) port 59 for exchanging MP3 data with a USB enabled device. Local storage 58 (hard drive) is provided for video and audio storage and 2D/3D graphics acceleration is provided within video interface 55 for use with games, applications, or electronic program guides. An Integrated WWW browser with javascript capability is provided within the video functions, so that users without a computer 25 connected to set-top interface 18 can connect to the Internet. Video-on-demand is supported via Real Time Streaming Protocol (RTSP) with pause, fast forward, and rewind functions and storage 58 can also be used for personal video recording.

Set-top interface 18 also provides high-speed Internet and data network access via a 10/100 mbit Ethernet interface 56 which will connect a personal computer 25 to set-top interface 18, providing best-effort high speed Internet connectivity.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A method for providing telephony, data and video services to a subscriber from a service provider, comprising the steps of:
acquiring video signals, telephony connections and internet connections;
grooming said video signals to produce a plurality of constant bit rate single program transport streams;
aggregating said transport streams with data associated with said Internet connections and said telephony connections to produce a unified Internet protocol (IP) formatted data stream;
broadcasting said unified data stream to one or more set-top boxes at subscriber premises.

2. The method of claim 1, wherein said aggregating provides a best-effort flow specification for said Internet connections, a rate-sensitive flow specification for said telephony connections and a delay-sensitive flow specification for said video transport streams.

3. The method of claim 1, further comprising controlling and monitoring customer access to said video transport stream and telephony components from said unified data stream, whereby access to pay services and billing for said access is automatically generated.

4. The method of claim 1, wherein said grooming produces a plurality of MPEG 2 encoded constant bit rate single program transport streams, and wherein said transport streams are further tagged with a channel identifier and Quality-of-Service parameters.

5. The method of claim 1, wherein said aggregating converts said video transport streams to multicast IP transmissions, and further comprising the steps of:
receiving a request to join a group of one of said multicast transmissions from a set-top box; and
in response to said receiving, determining whether or not a subscriber associated with said set-top box is permitted to receive said multicast transmission; and
in response to determining that said subscriber is permitted to receive said multicast transmission, adding said subscriber to said group.

6. The method of claim 1, further comprising inserting subscriber notifications and advertisement within said unified data stream, whereby a subscriber associated with a particular set-top box can receive said advertisements and notifications.

7. The method of claim 1, wherein said broadcasting broadcasts said unified data stream over a microwave radio transmission system.

8. The method of claim 7, wherein said microwave radio transmission system is an overlapping micro cell microwave transmission system.

9. A service provider system, comprising:
a video receiver for receiving a plurality of video signals;
a trunk interface for interfacing a plurality of telephonic connections;
an Internet gateway for providing data connections to the Internet;
a video processor for grooming said video signals to produce a plurality of constant bit rate single program transport streams;
an aggregation processor for aggregating said transport streams with data associated with said Internet connections and said telephony connections to produce a unified Internet protocol (IP) formatted data stream; and
a private network interface for broadcasting said unified data stream to one or more set-top boxes at subscriber premises.

10. The system of claim 9, wherein said aggregation processor provides a best-effort flow specification for said Internet connections, a rate-sensitive flow specification for said telephony connections and a delay-sensitive flow specification for said video transport streams.

11. The system of claim 9, wherein said aggregation processor further comprises an administrative component for controlling and monitoring customer access to said video transport stream and telephony components from said unified data stream, whereby access to pay services and billing for said access is automatically generated.

12. The system of claim 9, wherein said video processor produces a plurality of MPEG 2 encoded constant bit rate single program transport streams and tags said transport streams with a channel identifier and Quality-of-Service parameters.

13. The system of claim 9, wherein said aggregation processor converts said video transport streams to multicast IP transmissions, and wherein said aggregation receives a request to join a group of one of said multicast transmissions from a set-top box, determines whether or not a subscriber associated with said set-top box is permitted to receive said multicast transmission, and in response to determining that said subscriber is permitted to receive said multicast transmission, adds said subscriber to said group.

14. The system of claim 9, wherein said aggregation processor inserts subscriber notifications and advertisements within said unified data stream, whereby a subscriber associated with a particular set-top box can receive said advertisements and notifications.

15. The system of claim 9, further comprising a microwave radio transmission system coupled to said private network interface, whereby said unified data stream is broadcast over said microwave radio transmission system.

16. The system of claim 15, wherein said microwave radio transmission system is an overlapping micro cell microwave transmission system.

17. A set-top interface for connecting a subscriber location to a service provider facility that provides Internet data communications, telephony and video services to said subscriber, said set-top interface comprising:
a private network port for receiving a connection from said service provider facility, said connection carrying a unified Internet protocol (IP) formatted data stream containing telephony, video and Internet data communications components;
a demultiplexer for decomposing said telephony, video and Internet data communications components;
a video port for connection to an external video display, whereby said video display displays said video component;
a telephone interface for connection to an external telephone, whereby said external telephone sends and receives signals via said telephony component; and
a network interface for connecting an external computer, whereby said Internet data communications component provides Internet connectivity to said external computer.

18. The set-top interface of claim 17, wherein said unified data stream is delivered with a best-effort flow specification for said Internet connections, a rate-sensitive flow specification for said telephony connections and a delay-sensitive flow specification for said video transport streams.

19. The set-top interface of claim 17, further comprising a microwave transceiver coupled to said private network port, whereby said unified data stream is coupled to said demultiplexer.

20. The set-top interface of claim 17, further comprising a user interface for providing an interaction between a subscriber and an administrative component at said service provider facility, whereby said subscriber can select features of a service provider.
